(19) United States
(12) Patent Application Publication
(10) Pub. No.: US 2008/0142296 A1
(43) Pub. Date: Jun. 19, 2008

(54) Device for Roping Down a Load

(76) Inventor: Andre Jean, La Malbaie (CA)

Correspondence Address: Invention Quebec Inc., 8065, Boul. Viau Suite 202, Quebec, Montreal, H1R 2T2, omitted

(21) Appl. No.: 11/793,754

(22) PCT Filed: Dec. 23, 2005
(86) PCT No.: PCT/CA05/01974

§ 371 Date: Jun. 21, 2007

(30) Foreign Application Priority Data
Dec. 24, 2004 (GB) 0428335.4

(51) Int. Cl. A62B 1/16

(52) U.S. Cl. 182/5

(57) ABSTRACT

A device for roping down a load with a cable, the device includes a housing and a centrifugal brake assembly mounted within the housing. A shaft is mechanically coupled to the brake assembly. A pulley is provided for rotatably contacting the cable so that the rotational speed of the pulley substantially correlates with the longitudinal movement of the cable, the pulley is mechanically coupled to an outer segment of the shaft. The brake assembly includes an annular braking ring mounted within the housing defining a ring braking surface. A braking actuator is rotatably mounted inside the braking ring for rotation about a rotation axis. The braking actuator has three actuator arms extending outwardly. Three braking components each having a radially outwardly located braking surface are also provided. The braking components are mounted inside the braking ring for contacting a corresponding arm contacting surface and sliding therealong. The braking components are configured, sized and positioned so that upon rotation of the pulley, the rotation is transmitted via the shaft to the braking actuator and via the braking arms to the braking components. The rotation of the braking components generates a centrifugal force acting thereon for moving them radially outwardly until biasing their corresponding braking surfaces against the ring braking surface so as to generate a frictional braking force.

### FIELD OF THE INVENTION

The present invention relates to devices for roping down loads and is particularly concerned with a device for roping down a load incorporating a centrifugal-type braking assembly.

### BACKGROUND OF THE INVENTION

There exists a plurality of situations wherein it is desirable to lower or rope down a load such as a person or an object at a controlled speed. For example, it may be desirable to lower an object from the window of an apartment or warehouse for various purposes or it may be desirable to lower a person during an emergency situation. For example, it may be necessary to rescue people from relatively high floors during fires or other emergencies.

Prior art devices have been provided for helping a person being rescued to enjoy a reasonably controlled descent on the exterior of a building in the case of fire or other emergencies. Such prior art devices typically include a harness or safety belt secured to a casing wherein the cable is coiled on a reel that is connected to a braking mechanism.

Although somewhat useful, most prior art devices suffer from numerous drawbacks. For example, some of these devices are relatively heavy and cumbersome since the cable is coiled on a reel located inside the housing of the device. These devices may hence obstruct the emergency exit. Furthermore, the cable is subjected to the heat generated by the braking mechanism.

Some prior art devices require that the descent of the load be controlled by the user with some physical manipulation. This, in turn, requires that the user be physically capable of exerting the physical manipulation. However, in some cases, the load is too heavy. In other situations, for example, when the device is being used to lower an individual in an emergency situation, the individual may be incapacitated or even unconscious.

Some prior art devices used for roping down loads tend to rely on fluid energy dissipation for braking. However, since such devices are often stored for relatively long periods of time with minimal test and maintenance, such devices have a tendency to suffer from lack of reliability since fluid seals have a tendency to deteriorate and flow orifices to become blocked with deposits over time.

Accordingly, there exists a need for an improved device for roping down a load.

### SUMMARY OF THE INVENTION

It is a general object of the present invention to provide such an improved device for roping down a load.

In accordance with the present invention, there is provided a device for roping down a load with a cable, the device comprising a housing; a centrifugal brake assembly mounted within the housing; a shaft mechanically coupled to the centrifugal brake assembly, the shaft having a shaft outer segment extending outwardly from the housing; a pulley for rotatably contacting the cable so that the rotational speed of the pulley substantially correlates with the longitudinal movement of the cable, the pulley being mechanically coupled to the shaft outer segment; the centrifugal brake assembly including a substantially annular braking ring mounted within the housing, the braking ring defining a radially inwardly located ring braking surface; a braking actuator rotatably mounted inside the braking ring for rotation about a rotation axis, the braking actuator having at least one actuator arm extending substantially outwardly, the at least one actuator arm defining a radially inwardly located arm inner end, a radially outwardly located arm outer end and an arm contacting surface extending at least partially therebetween; at least one braking component having a radially outwardly located component braking surface, the at least one braking component being mounted inside the braking ring for contacting the arm contacting surface and sliding at least partially therealong; wherein the at least one braking component is configured, sized and positioned so that upon rotation of the pulley, the rotation is transmitted via the shaft to the braking actuator and via the at least one braking arm to the at least one braking component, the rotation of the at least one braking component generating a centrifugal force acting thereon for moving the at least one braking component radially outwardly from a radially inward position to a radially outward position until biasing the component braking surface against the ring braking surface so as to generate a frictional braking force therebetween.

Typically, the braking assembly includes three braking components separated from each other by three corresponding actuator arms, the component braking surfaces of the three braking components together forming a substantially annular configuration interrupted by the actuator arms that substantially corresponds to the configuration of the ring braking surface when contacting the ring braking surface, each of the braking components having a pair of opposed braking component end surfaces; the braking actuator including a substantially central actuator core, the actuator core being provided with a core aperture extending therethrough, the shaft extending through the core aperture for driving the braking actuator; the actuator arms extending substantially radially from the actuator core, each of the actuator arms having a pair of opposed arm contacting surfaces for contacting corresponding braking component end surfaces of adjacent braking components.

Conveniently, the housing has a pair of opposed housing main walls and a housing peripheral wall extending therebetween, the shaft-to-housing mounting means including a shaft mounting sleeve extending inwardly from each of the housing main walls for rotatably supporting the shaft; the shaft-to-housing mounting means also including a pair of shaft coupling protrusions extending substantially radially from the shaft, the shaft coupling protrusions being configured, sized and position so as to be respectively inserted into one of the shaft mounting sleeves for rotation therein relative thereto about the shaft longitudinal axis.

Preferably, the pulley is provided with a pulley friction enhancing means for enhancing the frictional force generated by the contact of the cable with the pulley. Typically, the pulley includes a substantially cylindrical pulley central section and a pair of pulley flanges extending substantially radially outwardly from the pulley central section, each of the pulley flanges defining a corresponding flange inner surface facing substantially towards the opposite pulley flange and an opposed flange outer surface, the pulley friction enhancing means including a friction enhancing texture formed on at least one of the flange inner surface. Typically, the friction enhancing texture includes a plurality of flange grooves extending substantially radially along the flange inner surfaces.

Conveniently, the pulley central section and the pulley flanges together define a substantially annular cable bed for receiving a longitudinal portion of the cable, the flange grooves are configured and sized so as to receive at least partially therein a peripheral portion of the cable when the longitudinal portion of the cable is inserted into the cable bed and a pulling force is exerted on the cable so as to allow the flange grooves to grip on the cable.

Typically, the device further comprises a contact area increasing means for increasing the size of the contact area between the cable and the cable bed. Typically, the cable defines a first cable end and an opposed second cable end, the cable being partially wrapped around the pulley about a cable contacting segment that contacts the cable bed, the cable defining a first cable strand and a second cable strand both extending from the cable contacting segment substantially adjacent to the pulley, the first cable strand extending in a first direction from the pulley towards the first cable end and the second cable strand extending in a second direction from the pulley towards the second cable end; the contact area increasing means including a pair of deflecting rollers rotatably attached to the device substantially adjacent to the pulley, the deflecting rollers being configured, sized and positioned for maintaining the cable contacting segment in contact with a substantial portion of the cable bed.

Conveniently, the device is further provided with a pulley-to-shaft clutch means for selectively transmitting the rotational movement of the pulley to the shaft depending on the direction of rotation of the pulley; whereby the pulley-to-shaft clutch means ensures that the shaft will rotate jointly with the pulley when a loaded end of the cable is being lowered so as to activate the centrifugal brake assembly and the pulley-to-shaft clutch means prevents the shaft from rotating jointly with the pulley when the loaded end of the cable is being raised so as to prevent the activation of the centrifugal brake assembly.

Typically, the pulley-to-shaft clutch means is a friction-type ratchet. Conveniently, the friction-type ratchet includes a ratchet sleeve attached to the pulley for rotating jointly therewith, the ratchet sleeve defining a ratchet sleeve channel for receiving the shaft, the ratchet sleeve having a ratchet sleeve inner surface, the ratchet sleeve being configured and sized so as to define a sleeve-to-shaft circumferential spacing between the ratchet sleeve inner surface and the shaft; at least one ratchet tooth located in the sleeve-to-shaft circumferential spacing for selectively coupling the shaft outer surface to the ratchet sleeve inner surface; at least one tooth receiving recess formed in the ratchet sleeve inner surface for selectively receiving at least a portion of the at least one ratchet tooth, the at least one tooth receiving recess being configured and sized so that when the at least one tooth is inserted therein the at least one tooth allows the shaft to rotate; a tooth biasing means for biasing the tooth out of the at least one tooth receiving recess; wherein the at least one tooth is configured and sized and the biasing means is calibrated such that when the ratchet sleeve is rotated in a first rotational direction, the frictional contact between the shaft and the at least one tooth combines with the biasing force generated by the tooth biasing means for moving the tooth away from the at least one tooth receiving recess until the at least one ratchet tooth is jammed between the ratchet sleeve inner surface and the shaft so as to couple the pulley and the shaft so that they rotate jointly together and, when the ratchet sleeve is rotated in a second rotational direction, the frictional contact between the shaft and the at least one ratchet tooth overrides the biasing force generated by the tooth biasing means and moves the at least one ratchet tooth towards the at least one tooth receiving recess allowing the ratchet sleeve to rotate independently from the shaft.

In an alternative embodiment of the invention, the device further includes a hoisting means coupled to the cable for selectively hoisting the load, the housing means being positioned intermediate the hoisting means and the load. Typically, the hoisting means includes a drum for winding the cable thereon. In one embodiment of the invention, the housing and the drum are mounted on a mounting frame, the mounting frame being pivotally attachable to a supporting surface.

In yet another embodiment of the invention, the device further includes an auxiliary pulley, the auxiliary pulley being rotatably mounted intermediate the housing and the load for redirecting the trajectory of the cable intermediate the housing and the load.

In accordance with the present invention, there is also provided, in combination, a cable and a device for roping down a load with the cable, the cable having a cable outer surface, the cable defining a cable outer diameter, the device comprising: a housing; a centrifugal brake assembly mounted within the housing; a shaft mechanically coupled to the centrifugal brake assembly, the shaft having a shaft outer segment extending outwardly from the housing; a pulley for rotatably contacting the cable so that the rotational speed of the pulley substantially correlates with the longitudinal movement of the cable, the pulley being mechanically coupled to the shaft outer segment; the centrifugal brake assembly including a substantially annular braking ring mounted within the housing, the braking ring defining a radially inwardly located ring braking surface; a braking actuator rotatably mounted inside the braking ring for rotation about a rotation axis, the braking actuator having at least one substantially outwardly extending actuator arm, the at least one actuator arm defining a radially inwardly located arm inner end, a radially outwardly located arm outer end and an arm contacting surface extending at least partially therebetween; at least one braking component having a radially outwardly located component braking surface, the braking component being mounted inside the braking ring for contacting the arm contacting surface and sliding at least partially therealong; wherein the at least one braking component is configured, sized and positioned so that upon rotation of the pulley, the rotation is transmitted via the shaft to the braking actuator and via the at least one braking arm to the at least one braking component, the rotation of the at least one braking component generating a centrifugal force acting thereon for moving the at least one braking component radially outwardly from a radially inward position to a radially outward position until biasing the component braking surface against the ring braking surface so as to generate a frictional braking force therebetween; the pulley including a substantially cylindrical pulley central section and a pair of pulley flanges extending substantially radially outwardly from the pulley central section, each of the pulley flanges defining a corresponding flange inner surface facing substantially towards the opposite pulley flange and an opposed flange outer surface, the pulley central section and the pulley flanges together defining a substantially annular cable bed for receiving a longitudinal portion of the cable, each of the pulley flanges defining a corresponding flange outer peripheral edge, at least one of the flange inner surfaces tapering inwardly towards the opposite flange inner surface in a direction leading from the corresponding flange outer peripheral edge towards the pulley central section; the cable diameter being sized such that the outer surface of the cable is spaced from the pulley central section, the outer surface of the cable only contacting the flange inner surfaces.

Advantages of the present invention include that the proposed device allows for a load to be lowered or roped down at a controlled speed using a cable. Control over the speed of descent of the load is obtained starting substantially at the initial phase of the lowering process and substantially throughout the lowering of the load. Indeed, the design of the device is such that the brake assembly responsible for controlling the speed of descent of the load is activated substantially as soon as the load starts to be lowered and the device is also designed so that the speed of descent of the load remains relatively constant throughout the lowering of the load.

Also, the device is designed so that the cable being used to lower the load is located outside of the housing protectively enclosing the braking assembly used for controlling the speed of descent of the load so as to thermally insulate the cable and associated pulley from the heat generated by the braking assembly.

The proposed device is further designed so as to reduce the risks of having the cable slip on the pulley part of the device used for transmitting the braking action to the cable.

Still furthermore, in at least some embodiments of the invention, the device is designed so that the brake assembly is only activated when a load is being lowered so as to prevent the brake assembly from affecting hoisting of the load.

Also, the proposed device is designed so as to incorporate a relatively small number of moving parts so as to be relatively simple in construction and so as to provide a device that will be economically feasible and relatively reliable.

### BRIEF DESCRIPTION OF THE DRAWINGS

Various embodiments of the invention will now be disclosed, by way of example, in reference to the following drawings in which:

FIG. 1, in a perspective view, illustrates a device for roping down a load in accordance with an embodiment of the present invention, the device being shown attached to the exterior frame of a window and being used for roping down an individual;

FIG. 2, in a perspective view, illustrates a device for roping down a load in accordance with an embodiment of the present invention, the device being shown with a cable operatively mounted thereto;

FIG. 3, in an exploded view, illustrates various components part of a device for roping down a load in accordance with an embodiment of the present invention;

FIG. 4, in an elevational view, illustrates a device for roping down a load in accordance with an embodiment of the present invention, the device being shown with a cable operatively mounted thereto;

FIG. 5a, in a side view, illustrates the device and cable shown in FIG. 4;

FIG. 5b, in a side view, illustrates the device shown in FIGS. 4 and 5a with the cable removed therefrom;

FIG. 6a, in an elevational view with sections taken out, illustrates some of the internal components of the device shown in FIGS. 1 through 5, the internal components being shown in a static configuration;

FIG. 6b illustrates the internal components shown in FIG. 6a being rotated with the centrifugal brake assembly activated;

FIG. 7, in a perspective view, illustrates a device in accordance with an alternative embodiment of the invention including a hoisting assembly;

FIG. 8, in a perspective view, illustrates a device in accordance with yet another embodiment of the invention further including an auxiliary pulley;

FIG. 9, in an elevational view, illustrates a device in accordance with yet another embodiment of the invention mounted on a mounting board;

FIG. 10, in a partial exploded view, illustrates some of the features of the pulley component part of a device in accordance with an embodiment of the present invention;

FIG. 11, in a partial elevational view with sections taken out, illustrates the pulley component shown in FIG. 10 in a partially assembled configuration about to be secured to a shaft and about to receive a cable;

FIG. 12, in a partial elevational view with sections taken out, illustrates the pulley component shown in FIGS. 10 and 11 mounted on a shaft and receiving a cable segment;

FIG. 13, in a perspective view, illustrates a pulley component part of a device in accordance with an embodiment of the present invention about to be assembled to an optional pulley-to-shaft clutch assembly;

FIG. 14, in a transversal cross-sectional view, illustrates some of the features of the pulley-to-shaft clutch assembly shown in FIG. 13.

### DETAILED DESCRIPTION

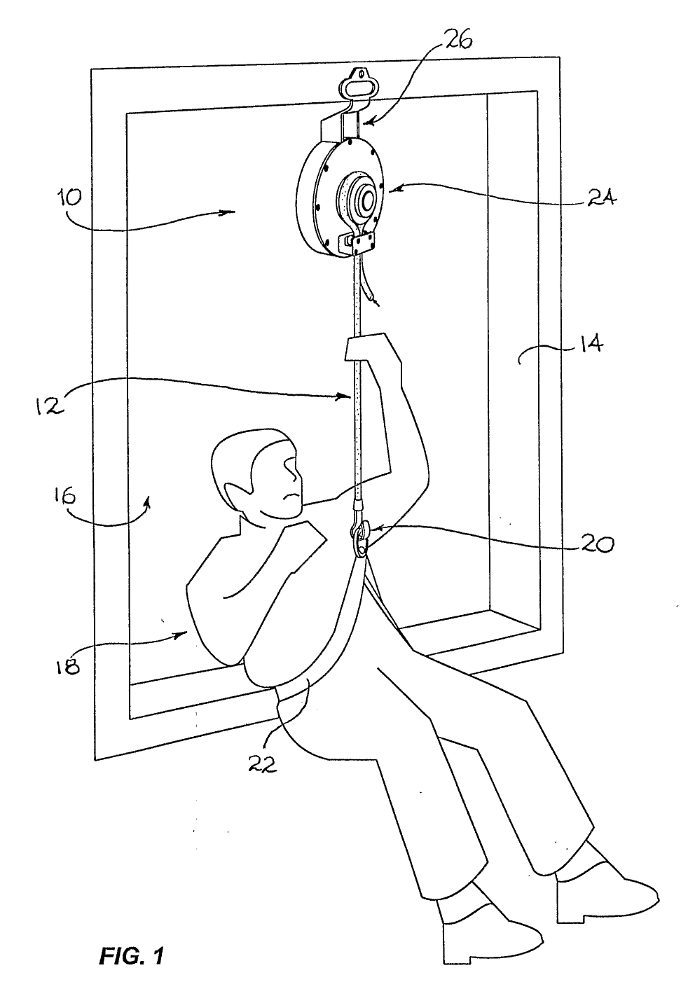

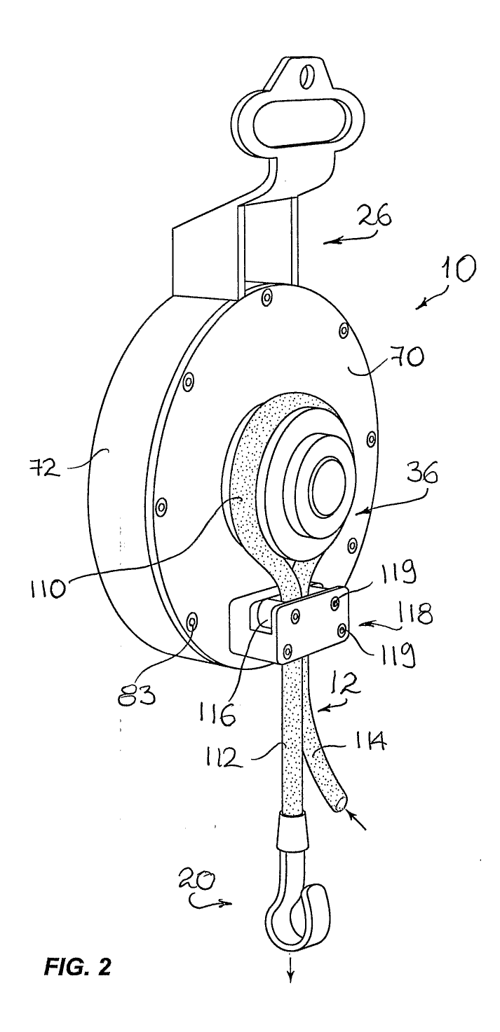

Referring to FIG. 1, there is shown a device for roping down a load in accordance with an embodiment of the present invention, generally indicated by the reference numeral 10. The device 10 is intended to be used with a cable 12 or any other suitable elongated and substantially flexible component such as a rope, a strap, a chain or the like.

The device 10 is shown in FIG. 1 attached to exterior frame 14 of a window opening 16 and being used for roping down a person 18. It should however be understood that the device 10 could be used in numerous other contexts for roping down any suitable load without departing from the scope of the present invention. For example, the device 10 may be used for roping down individuals in emergency situations or roping down objects or goods. The device 10 can also be used separately or in combination with other components for hoisting or raising objects or goods.

In FIG. 1, the device 10 is shown being used with a cable 12 provided with a hook 20 attached thereto. The hook 20 is shown being used for securing a harness 22 wrapped around the individual 18.

The device 10 includes a housing 24 for protectively enclosing some of its internal components. In FIG. 1, the housing 24 is shown secured to the window frame 14 by a housing mounting bracket 26. It should however be understood that the housing 24 could be secured, mounted or otherwise attached to any other suitable location using various types of brackets or other suitable assemblies without departing from the scope of the present invention.

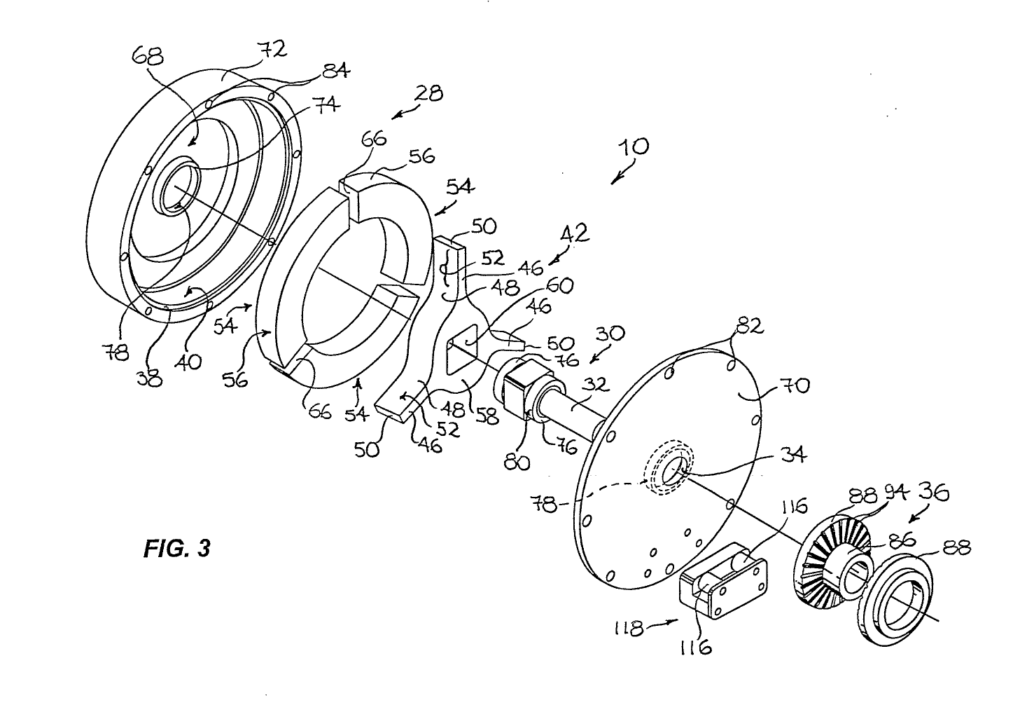

Referring now more specifically to FIG. 3, there is shown in greater details some of the components of the device 10. The device 10 includes a centrifugal brake assembly generally indicated by the reference numeral 28 mounted within the housing 24. A shaft, generally indicated by the reference numeral 30, is mechanically coupled to the centrifugal brake assembly 28. The shaft 30 has a shaft outer segment 32 extending outwardly from the housing 24 through a shaft aperture 34 provided in the housing 24.

A pulley generally indicated by the reference numeral 36 is mechanically coupled to the shaft outer segment 32. The pulley 36 is provided for rotatably contacting the cable 12 so that the rotational speed of the pulley 36 substantially correlates with the longitudinal movement of the cable 12.

The centrifugal brake assembly 28 includes a substantially annular braking ring 38 mounted within the housing 24. The braking ring 38 defines a radially inwardly located ring braking surface 40.

The centrifugal brake assembly 28 also includes a braking actuator generally indicated by the reference numeral 42 rotatably mounted inside the braking ring 38 for rotation about a rotation axis 44. The braking actuator 42 has at least one substantially outwardly extending actuator arm 46. The at least one actuator arm 46 defines a radially inwardly located arm inner end 48, a radially outwardly located arm 14 outer end 50 and an arm contacting surface 52 extending at least partially therebetween.

The centrifugal brake assembly 28 also includes at least one braking component 54 having a radially outwardly located component braking surface 56. The at least one braking component 54 is mounted inside the braking ring 38 for contacting the arm contacting surface 52 and sliding at least partially therealong.

Typically, the brake assembly 28 includes at least two braking components 54 and preferably three substantially arcuate braking components 54. The braking components 54 are separated from each other by corresponding actuator arms 46. Typically, at least one, and preferably all of the actuator arms 46, have a substantially parallepiped-shaped configuration.

The component braking surfaces 56 of the braking components 54 together form a substantially annular configuration interrupted by the actuator arms 46 that substantially corresponds to the configuration of the braking ring surface 40 when contacting the latter. In the preferred embodiment, each of the three braking components 54 has substantially the configuration of an arc segment extending substantially across 120 degrees.

Each of the braking components 54 typically has a pair of opposed braking components end surfaces 66. Each of the actuator arms 46 defines a pair of opposed arm contacting surfaces 52 for contacting corresponding braking component end surfaces 66 of adjacent braking component 54.

Typically, the ring braking surface 40 and/or the component braking surfaces 56 are provided with friction-increasing means for increasing their respective friction coefficients. The friction-increasing means may take any suitable form such as a friction-increasing texture, lining or the like.

The braking actuator 42 typically includes a substantially central actuator core 58. The actuator arms 46 typically extend integrally from the actuator core 58. The actuator core 58 is provided with a core aperture 60 extending therethrough. The shaft 30 is adapted to extend through the core aperture 60 for driving the brake actuator 42.

Typically, the shaft 30 is provided with a shaft-to-actuator coupling protrusion 62 extending substantially radially therefrom. The actuator core 58 is configured and sized for substantially fittingly receiving the shaft-to-actuator coupling protrusion 62. The shaft-to-actuator coupling protrusion 62 typically defines at least two, and preferably four, outer faces. It should be understood that the shaft-to-actuator coupling protrusion 62 could have any other suitable configuration such as a substantially polyhedral configuration or the like without departing from the scope of the present invention.

The shaft 30 defines a shaft longitudinal axis. The device 10 is provided with a shaft-to-housing mounting means for rotatably mounting the shaft 30 to the housing 24 so as to allow the shaft 30 to rotate relative to the housing 24 about the shaft longitudinal axis. Typically, the housing 24 has a pair of opposed housing main walls 68, 70, and a housing peripheral wall 72 extending therebetween.

The shaft-to-housing mounting means typically includes a shaft mounting sleeve 74 extending inwardly from at least one and preferably both, of the housing main walls 68, 70, for rotatably supporting the shaft 30. The shaft-to-housing mounting means typically also includes at least one, and preferably two, shaft coupling protrusions or bushings 76 extending substantially radially from the shaft 30. The shaft coupling protrusions 76 are configured, sized and positioned so as to be inserted into corresponding shaft mounting sleeves 74 for rotation therein relative thereto about the shaft longitudinal axis.

Each shaft mounting sleeve 74 defines a corresponding substantially annular sleeve inner surface 78. Each coupling protrusion 76 defines a corresponding substantially annular protrusion outer surface 80. The sleeve inner surfaces 78 and/or the protrusion outer surfaces 80 are typically provided with a friction reducing means for reducing the friction between corresponding sleeve inner surfaces 78 and protrusion outer surfaces 80.

In the embodiment shown throughout the Figures, the housing main walls 68, 70 have a substantially disc-shaped configuration and the housing peripheral wall 72 has a corresponding substantially cylindrical configuration. It should, however, be understood that the housing main walls 68, 70 and the housing peripheral wall 72 could have other configurations without departing from the scope of the present invention. In fact, the housing 24 could include any suitable number of walls and the configuration of such walls could vary so that the overall configuration of the housing 24 could vary without departing from the scope of the present invention.

In the embodiment shown throughout the Figures, the housing peripheral wall 72 defines a peripheral wall inner surface having a substantially annular configuration and the braking ring 38 is secured to the peripheral wall inner surface.

Also, in the embodiment shown throughout the Figures, the housing peripheral wall 72 extends from the housing main wall 68 while the housing main wall 70 is releasably secured to the housing peripheral wall 72. It should, however, be understood that the housing peripheral wall 72 could extend from the housing main wall 70 or that the overall connectivity between the housing main walls 68, 70 and the housing peripheral walls 72 could vary without departing from the scope of the present invention.

As shown in FIG. 3, typically, the housing main wall 70 is provided with main wall attachment apertures 82 extending therethrough substantially adjacent its peripheral edge. The housing peripheral wall 72 is provided with corresponding peripheral wall attachment apertures 84 about its peripheral edge. The main wall and housing attachment apertures 82, 84 are adapted to be put in register with each other for receiving suitable fastening components such as bolts 83 or the like for releasably attaching the housing main wall 70 to the housing peripheral wall 84.

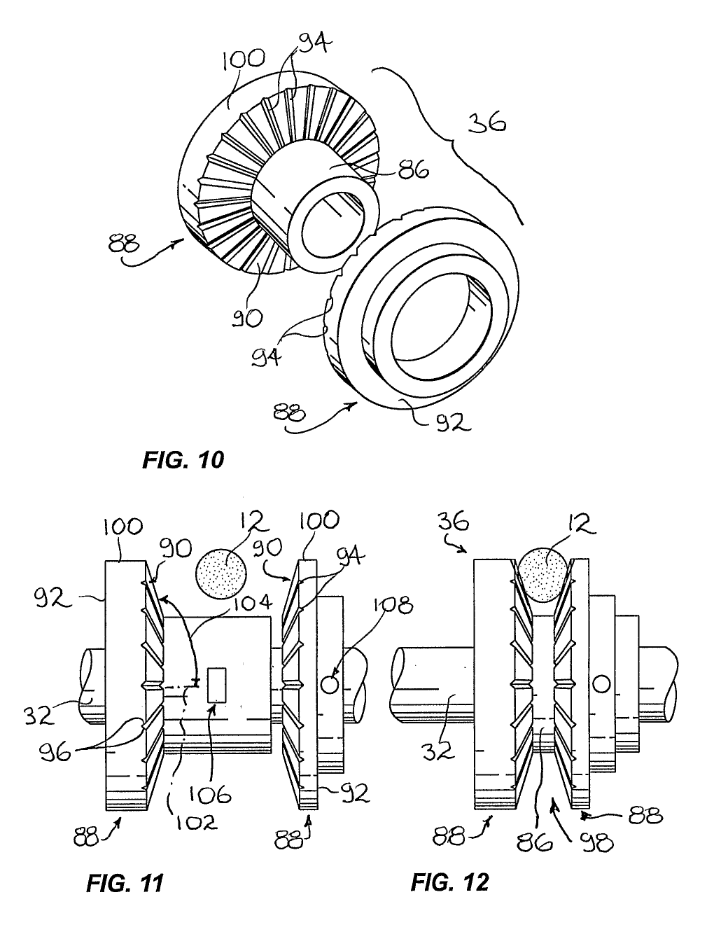

Referring now more specifically to FIGS. 10 through 12, there is shown in greater details some of the features of the pulley 36. The pulley 36 typically includes a substantially cylindrical pulley central section 86 and a pair of pulley flanges 88 extending substantially radially outwardly from the pulley central section 86. Each of the pulley flanges 88 defines a corresponding flange inner surface 90 facing substantially towards the opposite pulley flange 88 and an opposed flange outer surface 92.

The pulley 36 is typically provided with a pulley friction enhancing means for enhancing the frictional force generated by the contact of the cable 12 with the pulley 36. The pulley friction enhancing means typically includes a friction enhancing texture or the like formed on at least one of the flange inner surfaces 90 and preferably both flange inner surfaces 90. Typically, the friction-enhancing texture includes at least one flange groove 94 and preferably a plurality of flange grooves 94 extending substantially radially along at least a portion of at least one of the flange inner surfaces 90 and preferably along both flange inner surfaces 90.

By performing certain experiments, it has been determined that the preferred number of flange grooves 94 for providing an improved frictional force with the cable 12 is approximately 24 for each flange inner surface 90. It should, however, be understood that any other suitable number of flange grooves 94 could be used without departing from the scope of the present invention.

Each flange groove 94 typically has a substantially V-shaped cross-sectional configuration. Typically, each V-shaped flange groove 94 defines a pair of corresponding groove wall segments 96. Typically, the groove wall segments 96 of a given flange groove 94 are angled relative to each other by a groove wall segment angle having a value of approximately 30 degrees. It should, however, be understood that the cross-sectional configuration of the flange grooves 94 could vary without departing from the scope of the present invention.

As illustrated more specifically in FIG. 12, the pulley central section 86 and the pulley flanges 88 together define a substantially annular cable bed 98 for receiving a longitudinal portion of the cable 12. The flange grooves 94 are configured and sized so as to receive at least partially therein a peripheral portion of the cable 12 when the longitudinal portion of the cable 12 is inserted into the cable bed 98 and a pulling force is exerted on the cable 12 so as to allow the flange grooves 94 to grip on the cable 12.

Each pulley flange 88 defines a corresponding flange outer peripheral edge 100. At least one of the flange inner surfaces 90 and preferably both flange inner surfaces 90 taper inwardly towards the opposite flange inner surface 90 in a direction leading from the corresponding flange outer peripheral edge 100 towards the pulley central section 86 so that the cable bed 98 has a substantially V-shaped cross-sectional configuration.

Typically, the pulley central section 86 defines a central section axis 102. The pulley 36 is mounted for rotation about the central section axis 102. The flange inner surfaces 90 are typically angled so as to form an inner surface-to-axis angle 104 relative to the central section axis 102. The inner surface-to-axis angle 104 typically has a value of between 95 degrees and 105 degrees. It should, however, be understood that the inner surface-to-axis angle 104 could have other suitable values without departing from the scope of the present invention.

In the embodiments shown throughout the Figures, the pulley central section 86 and one of the pulley flanges 88 are attached together. The combined central section 86 and attached pulley flange 80 are attached together on the shaft outer segment 32 by a first pulley-to-shaft attachment means schematically illustrated in FIG. 11 and referred to by the reference numeral 106. The other pulley flange 80 is attached on the shaft outer segment 32 by a second pulley-to-shaft attachment means schematically illustrated in FIG. 11 and referred to by the reference numeral 108.

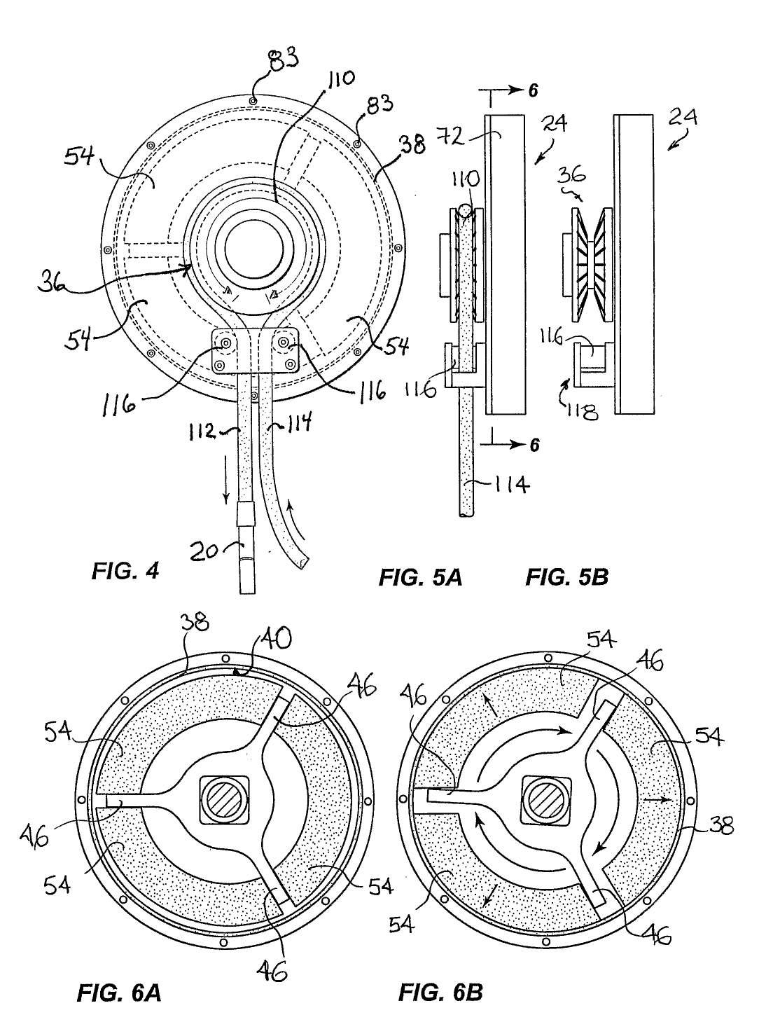

The cable 12 defines a first cable end and an opposed section cable end. As shown more specifically in FIG. 4, the cable 12 is partially wrapped around the pulley 36 about a cable contacting segment 110 that contacts the cable bed 98. The cable 12 defines a first cable strand 112 and a second cable strand 114 both extending from the cable contacting segment 110 substantially adjacent the pulley 36. The first cable strand 112 extends in a first strand direction from the pulley 36 towards the first cable end and the second cable strand 114 extends in a second strand direction from the pulley 36 towards the second cable end.

The device 10 is typically further provided with a contact area increasing means for increasing the size of the contact area between the cable 12 and the cable bed 98. The contact area increasing means typically includes a pair of deflecting rollers 116 rollably attached to the device 10 substantially adjacent to the pulley 36. The deflecting rollers 116 are configured, sized and positioned for maintaining the cable contacting segment 110 in contact with a substantial portion of the cable bed 98.

The deflecting rollers 116 are typically configured, size and positioned so that the cable contacting segment 110 is in contact with approximately 80% of the circumference of the cable bed 98. Also, the deflecting rollers 116 are typically configured, sized and positioned for maintaining the first and second cable strands 112, 114 in a substantially parallel relationship relative to each other adjacent to the pulley 36.

The deflecting rollers 116 are hence adapted to allow for a high envelope angle. The deflecting rollers 116 are also adapted to reduce the risks of having the first and second cable strands 112, 114 cross or twist and or having the cable contacting segment 110 move out of the cable bed 98.

As illustrated more specifically in FIG. 3, the deflecting rollers 116 are typically rollably mounted to a roller mounting bracket 118. The roller mounting bracket 118 is, in turn, typically attached to the housing main wall 70 through bolt attachment means 119 or the like typically adjacent to the pulley 36.

The device 10 is optionally further provided with a pulley-to-shaft clutch means for selectively transmitting he rotational movement of the pulley 36 to the shaft 30 depending on the direction of rotation of the pulley 36. The pulley-to-shaft clutch means ensures that the shaft 30 will rotate jointly with the pulley 36 when a loaded end of the cable 12 is being lowered so as to activate the centrifugal brake assembly.

The pulley-shaft-clutch means also prevents the shaft 30 from rotating jointly with the pulley 36 when the loaded end of the cable 12 is being raised so as to prevent the activation of the centrifugal brake assembly when hoisting a load.

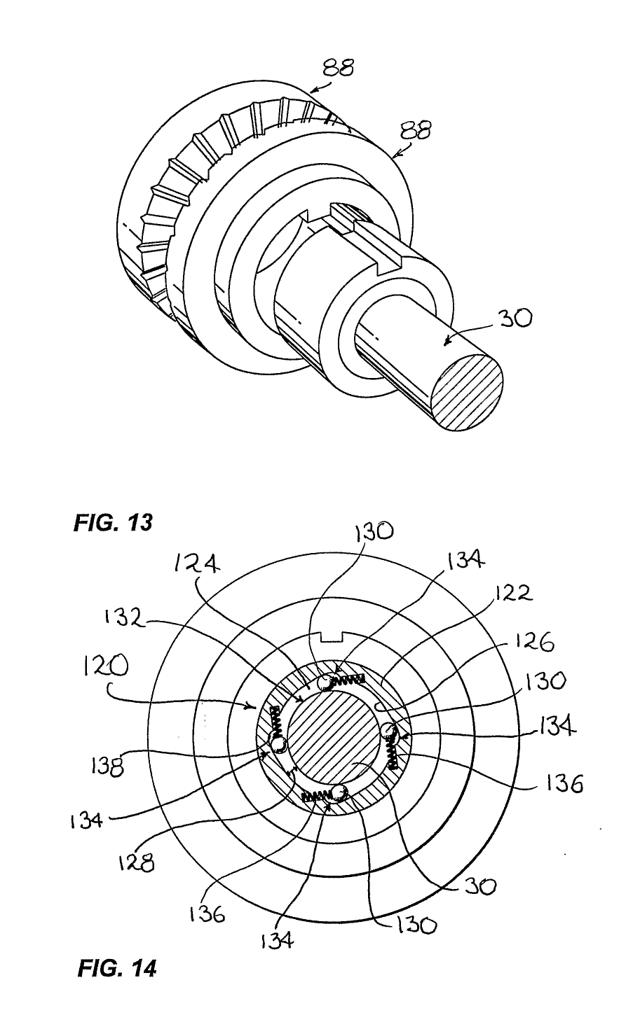

As illustrated more specifically in FIGS. 13 and 14, the pulley-to-shaft clutch means typically includes a friction-type ratchet generally indicated by the reference numeral 120. The friction-type ratchet 120 includes a ratchet sleeve 122 attached to the pulley 36 for rotating jointly therewith.

The ratchet sleeve 122 defines a ratchet sleeve channel 124 for receiving the shaft 30. The ratchet sleeve 122 has a ratchet sleeve inner surface 126. The ratchet sleeve inner surface 126 is configured and sized so as to define a sleeve-to-shaft circumferential spacing 128 between the ratchet sleeve inner surface 126 and the shaft 30.

At least one ratchet teeth 130, and preferably four ratchet teeth 130 are located in the sleeve-to-shaft circumferential spacing 128 for selectively coupling the shaft outer surface 132 to the ratchet sleeve inner surface 126. At least one tooth receiving recess 134, and preferably four tooth receiving recesses 134 are formed in the ratchet sleeve inner surface 126 for selectively receiving at least a portion of a corresponding ratchet tooth 130. The tooth receiving recesses 134 are configured and sized so that when corresponding ratchet teeth 130 are inserted therein, the ratchet teeth 130 allow the shaft 30 to rotate.

The friction type ratchet 120 further includes a tooth biasing means for biasing the ratchet teeth 130 out of the corresponding tooth receiving recesses 134. The ratchet teeth 130 are configured and sized and the biasing means is calibrated such that when the ratchet sleeve 122 is rotated in a first rotational direction, the frictional contact between the shaft outer surface 132 and the ratchet teeth 130 combines with the biasing force generated by the tooth biasing means for moving the ratchet teeth 130 away from their corresponding tooth receiving recesses 134 until the ratchet teeth 130 are jammed between the ratchet sleeve inner surface 126 and the shaft 30 so as to couple the pulley 36 and the shaft 30 so that they rotate jointly together.

Conversely, when the ratchet sleeve 122 is rotated in an opposite second rotational direction, the frictional contact between the shaft outer surface 132 and the ratchet teeth 130 overrides the biasing force generated by the tooth biasing means and moves the ratchet teeth 130 towards their corresponding tooth receiving recesses 134 allowing the ratchet sleeve 122 to rotate independently from the shaft 30.

Typically, although by no means exclusively, at least one ratchet tooth 130, and preferably all of the ratchet teeth 130, have a substantially spherical configuration. Also, typically, although by no means exclusively, the biasing means includes helicoidal-type springs 136 extending between each ratchet tooth 130 and the ratchet sleeve 122. Typically, although by no means exclusively, the tooth receiving recesses 134 spiral radially outwardly and define corresponding tooth seats 138 adjacent a bottom section thereof.

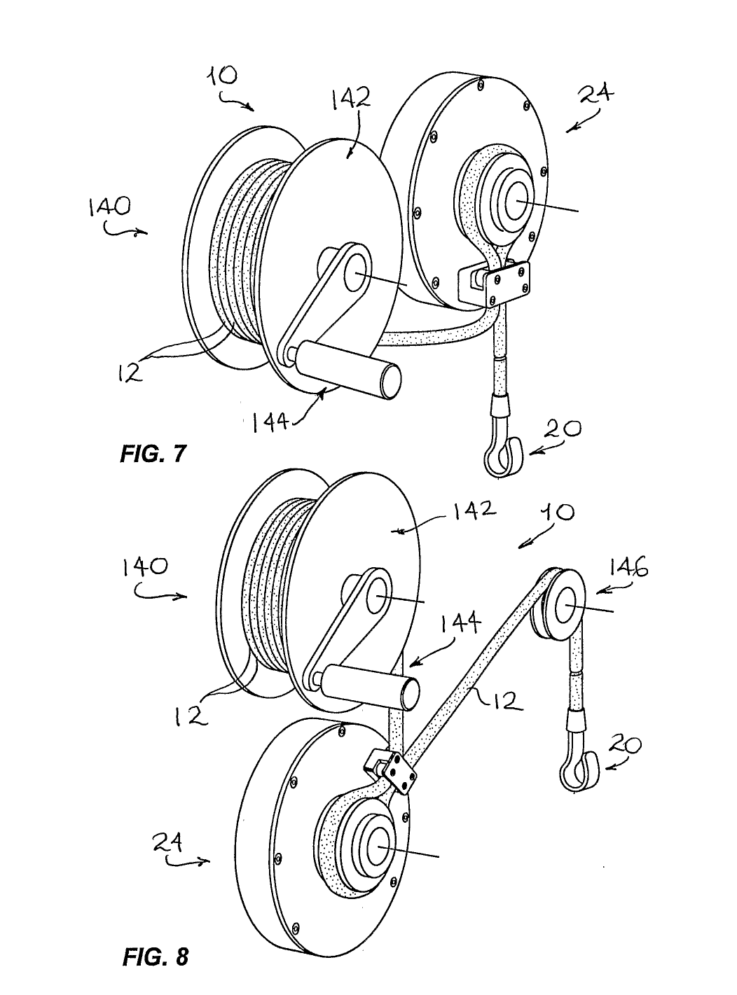

As illustrated in FIGS. 7 through 9, the device 10 may optionally further be provided with a hoisting means generally indicated by the reference numeral 140 coupled to the cable 12 for selectively hoisting the load. The housing 24 is typically positioned intermediate the hoisting means 140 and the load. In the embodiment shown throughout the Figures, the hoisting means 140 includes a drum 142 for winding the cable 12 thereon. The drum 142 may be provided with any suitable type of drum rotation means. For example, the drum 142 may be provided with a drum handle 144 mechanically coupled thereto for allowing manual rotation of the drum 142.

FIG. 8 illustrates yet another alternative embodiment of the invention wherein the device 10 is still further provided with an auxiliary pulley 146. The auxiliary pulley 146 is rotatably mounted intermediate the housing 24 and the load for redirecting the trajectory of the cable 12 intermediate the housing 24 and the load.

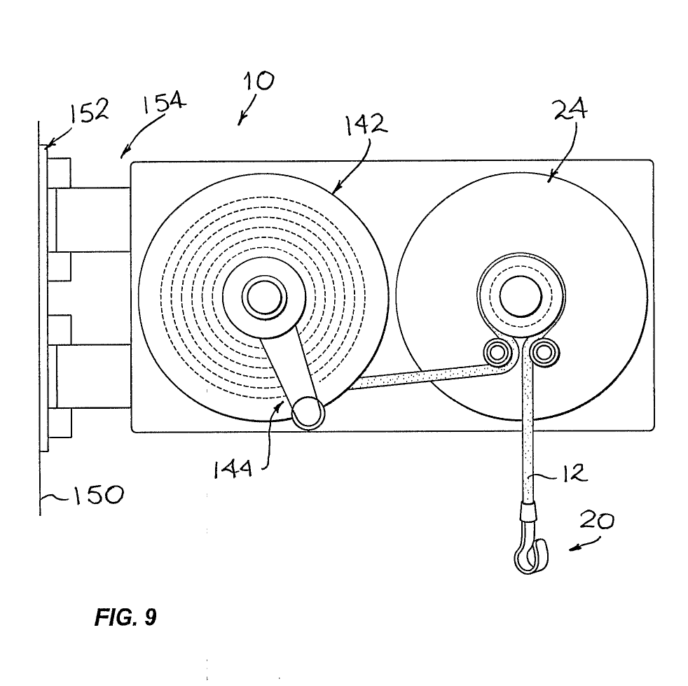

FIG. 9 illustrates yet another alternative embodiment of the invention wherein the housing 24 and the drum 142 are both mounted on a mounting frame 148. The mounting frame 148 is, in turn, pivotally attachable to a supporting surface such as a wall 150 using a mounting plate 152 and a hinge mechanism generally indicated by the reference numeral 154.

The embodiments of the invention in which an exclusive privilege or property is claimed are defined as follows:

1. A device for roping down a load with a cable, said device comprising:
a housing;
a centrifugal brake assembly mounted within said housing;
a shaft mechanically coupled to said centrifugal brake assembly, said shaft having a shaft outer segment extending outwardly from said housing;
a pulley for rotatably contacting said cable so that the rotational speed of said pulley substantially correlates with the longitudinal movement of said cable, said pulley being mechanically coupled to said shaft outer segment;
said centrifugal brake assembly including
a substantially annular braking ring mounted within said housing, said braking ring defining a radially inwardly located ring braking surface;
a braking actuator rotatably mounted inside said braking ring for rotation about a rotation axis, said braking actuator having at least one actuator arm extending substantially outwardly, said at least one actuator arm defining a radially inwardly located arm inner end, a radially outwardly located arm outer end and an arm contacting surface extending at least partially therebetween;
at least one braking component having a radially outwardly located component braking surface, said at least one braking component being mounted inside said braking ring for contacting said arm contacting surface and sliding at least partially therealong;
wherein said at least one braking component is configured, sized and positioned so that upon rotation of said pulley, said rotation is transmitted via said shaft to said braking actuator and via said at least one braking arm to said at least one braking component, the rotation of said at least one braking component generating a centrifugal force acting thereon for moving said at least one braking component radially outwardly from a radially inward position to a radially outward position until biasing said component braking surface against said ring braking surface so as to generate a frictional braking force therebetween.

2. A device as recited in claim 1 wherein said braking assembly includes at least two braking components separated from each other by at least two corresponding actuator arms, said component braking surfaces of said at least two braking components together forming a substantially annular configuration interrupted by said actuator arms that substantially corresponds to the configuration of said ring braking surface when contacting said ring braking surface.

3. A device as recited in claim 2 wherein said braking assembly includes three substantially arcuate braking components and three corresponding actuator arms, said braking components having substantially the configuration of arc segments each extending substantially across 120 degrees.

4. A device as recited in claim 1 wherein said ring braking surface is provided with a friction increasing means for increasing its friction coefficient.

5. A device as recited in claim 1 wherein said component braking surface is provided with a friction increasing means for increasing its friction coefficient.

6. A device as recited in claim 1 wherein both said component braking surface and said ring braking surface are provided with a friction increasing means for increasing their respective friction coefficients.

7. A device as recited in claim 1 wherein said braking actuator includes a substantially central actuator core and wherein said at least one actuator arm extends from said actuator core, said actuator core being provided with a core aperture extending therethrough, said shaft extending through said core aperture for driving said braking actuator.

8. A device as recited in claim 7 wherein said shaft is provided with a shaft-to-actuator coupling protrusion extending substantially radially therefrom, said actuator core being configured and sized for substantially fittingly receiving said shaft-to-actuator coupling protrusion.

9. A device as recited in claim 8 wherein said shaft-to-actuator coupling protrusion defines at least two outer faces.

10. A device as recited in claim 1 wherein said braking assembly includes three braking components separated from each other by three corresponding actuator arms, said component braking surfaces of said three braking components together forming a substantially annular configuration interrupted by said actuator arms that substantially corresponds to the configuration of said ring braking surface when contacting said ring braking surface, each of said braking components having a pair of opposed braking component end surfaces; said braking actuator including a substantially central actuator core, said actuator core being provided with a core aperture extending therethrough, said shaft extending through said core aperture for driving said braking actuator; said actuator arms extending substantially radially from said actuator core, each of said actuator arms having a pair of opposed arm contacting surfaces for contacting corresponding braking component end surfaces of adjacent braking components.

11. A device as recited in claim 10 wherein at least one of said actuator arm has a substantially parallelepiped-shaped configuration.

12. A device as recited in claim 10 wherein at least one of said actuator arm extends integrally from said actuator core.

13. A device as recited in claim 1 wherein said shaft defines a shaft longitudinal axis; said device being provided with a shaft-to-housing mounting means for rotatably mounting said shaft to said housing so as to allow said shaft to rotate relative to said housing about said shaft longitudinal axis.

14. A device as recited in claim 1 wherein said housing has a pair of opposed housing main walls and a housing peripheral wall extending therebetween, said shaft-to-housing mounting means including a shaft mounting sleeve extending inwardly from at least one of said housing main walls for rotatably supporting said shaft.

15. A device as recited in claim 14 wherein said shaft-to-housing mounting means includes at least one shaft coupling protrusion extending substantially radially from said shaft, said at least one shaft coupling protrusion being configured, sized and positioned so as to be inserted into said at least one shaft mounting sleeve for rotation therein relative thereto about said shaft longitudinal axis.

16. A device as recited in claim 1 wherein said housing has a pair of opposed housing main walls and a housing peripheral wall extending therebetween, said shaft-to-housing mounting means including a shaft mounting sleeve extending inwardly from each of said housing main walls for rotatably supporting said shaft; said shaft-to-housing mounting means also including a pair of shaft coupling protrusions extending substantially radially from said shaft, said shaft coupling protrusions being configured, sized and position so as to be respectively inserted into one of said shaft mounting sleeves for rotation therein relative thereto about said shaft longitudinal axis.

17. A device as recited in claim 15 wherein said at least one shaft mounting sleeve defines a substantially annular sleeve inner surface and said at least one shaft coupling protrusion defines a corresponding substantially annular protrusion outer surface, said sleeve inner surface being provided with a friction reducing means for reducing the friction between said sleeve inner surface and said protrusion outer surface.

18. A device as recited in claim 15 wherein said at least one shaft mounting sleeve defines a substantially annular sleeve inner surface and said at least one shaft coupling protrusion defines a corresponding substantially annular protrusion outer surface, said protrusion outer surface being provided with a friction reducing means for reducing the friction between said sleeve inner surface and said protrusion outer surface.

19. A device as recited in claim 15 wherein said at least one shaft mounting sleeve defines a substantially annular sleeve inner surface and said at least one shaft coupling protrusion defines a corresponding substantially annular protrusion outer surface, said sleeve inner surface and said protrusion outer surface being both provided with a friction reducing means for reducing the friction between said sleeve inner surface and said protrusion outer surface.

20. A device as recited in claim 14 wherein said housing main walls have a substantially disc-shaped configuration and said housing peripheral wall has a corresponding substantially cylindrical configuration.

21. A device as recited in claim 20 wherein said housing peripheral wall defines a peripheral wall inner surface, said braking ring being secured to said peripheral wall inner surface.

22. A device as recited in claim 20 wherein said housing peripheral wall extends from one of said housing main walls and the other one of said housing main walls is releasably secured to said housing peripheral wall.

23. A device as recited in claim 1 wherein said pulley is provided with a pulley friction enhancing means for enhancing the frictional force generated by the contact of said cable with said pulley.

24. A device as recited in claim 23 wherein said pulley includes a substantially cylindrical pulley central section and a pair of pulley flanges extending substantially radially outwardly from said pulley central section, each of said pulley flanges defining a corresponding flange inner surface facing substantially towards the opposite pulley flange and an opposed flange outer surface, said pulley friction enhancing means including a friction enhancing texture formed on at least one of said flange inner surface.

25. A device as recited in claim 24 wherein said friction enhancing texture includes at least one flange groove extending substantially radially along at least a portion of at least one of said flange inner surfaces.

26. A device as recited in claim 24 wherein said friction enhancing texture includes a plurality of flange grooves extending substantially radially along said flange inner surfaces.

27. A device as recited in claim 26 wherein said flange grooves have a substantially “V”-shaped cross-sectional configuration.

28. A device as recited in claim 26 wherein said pulley central section and said pulley flanges together define a substantially annular cable bed for receiving a longitudinal portion of said cable, said flange grooves are configured and sized so as to receive at least partially therein a peripheral portion of said cable when said longitudinal portion of said cable is inserted into said cable bed and a pulling force is exerted on said cable so as to allow said flange grooves to grip on said cable.

29. A device as recited in claim 28 wherein each of said pulley flanges defines a corresponding flange outer peripheral edge, at least one of said flange inner surfaces tapering inwardly towards the opposite flange inner surface in a direction leading from the corresponding flange outer peripheral edge towards said pulley central section.

30. A device as recited in claim 28 wherein each of said pulley flanges defines a corresponding flange outer peripheral edge, said flange inner surfaces tapering inwardly towards the opposite flange inner surface in a direction leading from the corresponding flange outer peripheral edge towards said pulley central section so that said cable bed has a substantially “V”-shaped cross-sectional configuration.

31. A device as recited in claim 30 wherein said pulley central section defines a central section axis, said pulley being mounted for rotation about said central section axis, said flange inner surfaces tapering towards each other in a direction leading from the corresponding flange outer peripheral edge towards said pulley central section so as to form an inner surface-to-axis angle having a value of between 95 degrees and 105 degrees relative to said central section axis.

32. A device as recited in claim 31 wherein said pulley central section and one of said pulley flanges are attached together and are attached on said shaft by a first pulley-to-shaft attachment means, the other pulley flange being attached on said shaft by a second pulley-to-shaft attachment means.

33. A device as recited in claim 28 further comprising a contact area increasing means for increasing the size of the contact area between said cable and said cable bed.

34. A device as recited in claim 33 wherein said cable defines a first cable end and an opposed second cable end, said cable being partially wrapped around said pulley about a cable contacting segment that contacts said cable bed, said cable defining a first cable strand and a second cable strand both extending from said cable contacting segment substantially adjacent to said pulley, said first cable strand extending in a first direction from said pulley towards said first cable end and said second cable strand extending in a second direction from said pulley towards said second cable end; said contact area increasing means including a pair of deflecting rollers rotatably attached to said device substantially adjacent to said pulley, said deflecting rollers being configured, sized and positioned for maintaining said cable contacting segment in contact with a substantial portion of said cable bed.

35. A device as recited in claim 34 wherein said deflecting rollers are configured, sized and positioned so that said cable contacting segment is in contact with approximately 80% of the circumference of said cable bed.

36. A device as recited in claim 34 wherein said deflecting rollers being configured, sized and positioned for maintaining said first and second cable strands in a substantially parallel relationship relative to each other.

37. A device as recited in claim 34 wherein said housing includes a pair of opposed housing main walls and a housing peripheral wall extending therebetween, said deflecting rollers are rollably mounted to a roller mounting bracket, said roller mounting bracket being attached to one of said housing main walls substantially adjacent to said pulley.

38. A device as recited in claim 1 wherein said device is further provided with a pulley-to-shaft clutch means for selectively transmitting the rotational movement of said pulley to said shaft depending on the direction of rotation of said pulley; whereby said pulley-to-shaft clutch means ensures that said shaft will rotate jointly with said pulley when a loaded end of said cable is being lowered so as to activate said centrifugal brake assembly and said pulley-to-shaft clutch means prevents said shaft from rotating jointly with said pulley when said loaded end of said cable is being raised so as to prevent the activation of said centrifugal brake assembly.

39. A device as recited in claim 38 wherein said pulley-to-shaft clutch means is a friction-type ratchet.

40. A device as recited in claim 39 wherein said friction-type ratchet includes
a ratchet sleeve attached to said pulley for rotating jointly therewith, said ratchet sleeve defining a ratchet sleeve channel for receiving said shaft, said ratchet sleeve having a ratchet sleeve inner surface, said ratchet sleeve being configured and sized so as to define a sleeve-to-shaft circumferential spacing between said ratchet sleeve inner surface and said shaft;
at least one ratchet tooth located in said sleeve-to-shaft circumferential spacing for selectively coupling said shaft outer surface to said ratchet sleeve inner surface;
at least one tooth receiving recess formed in said ratchet sleeve inner surface for selectively receiving at least a portion of said at least one ratchet tooth, said at least one tooth receiving recess being configured and sized so that when said at least one tooth is inserted therein said at least one tooth allows said shaft to rotate;
a tooth biasing means for biasing said tooth out of said at least one tooth receiving recess;
wherein said at least one tooth is configured and sized and said biasing means is calibrated such that
when said ratchet sleeve is rotated in a first rotational direction, the frictional contact between said shaft and said at least one tooth combines with the biasing force generated by said tooth biasing means for moving said tooth away from said at least one tooth receiving recess until said at least one ratchet tooth is jammed between said ratchet sleeve inner surface and said shaft so as to couple said pulley and said shaft so that they rotate jointly together and,
when said ratchet sleeve is rotated in a second rotational direction, the frictional contact between said shaft and said at least one ratchet tooth overrides the biasing force generated by said tooth biasing means and moves said at least one ratchet tooth towards said at least one tooth receiving recess allowing said ratchet sleeve to rotate independently from said shaft.

41. A device as recited in claim 40 wherein said friction-type ratchet includes four ratchet teeth, four corresponding tooth receiving recesses and four corresponding biasing means circumferentially distributed in said sleeve-to-shaft circumferential spacing.

42. A device as recited in claim 40 wherein said at least one ratchet tooth has a substantially spherical configuration.

43. A device as recited in claim 40 wherein said biasing means includes a helicoidal-type spring extending between said at least one tooth and said ratchet sleeve.

44. A device as recited in claim 40 wherein said at least one tooth receiving recess spirals radially outwardly and defines a tooth seat adjacent a bottom section thereof.

45. A device as recited in claim 1 further comprising a hoisting means coupled to said cable for selectively hoisting said load, said housing means being positioned intermediate said hoisting means and said load.

46. A device as recited in claim 45 wherein said hoisting means includes a drum for winding said cable thereon.

47. A device as recited in claim 46 wherein said drum is provided with a drum handle coupled thereto for allowing manual rotation of said drum.

48. A device as recited in claim 46 wherein said housing and said drum are mounted on a mounting frame, said mounting frame being pivotally attachable to a supporting surface.

49. A device as recited in claim 46 further comprising an auxiliary pulley, said auxiliary pulley being rotatably mounted intermediate said housing and said load for redirecting the trajectory of said cable intermediate said housing and said load.

50. In combination, a cable and a device for roping down a load with said cable, said cable having a cable outer surface, said cable defining a cable outer diameter, said device comprising:
a housing;
a centrifugal brake assembly mounted within said housing;
a shaft mechanically coupled to said centrifugal brake assembly, said shaft having a shaft outer segment extending outwardly from said housing;
a pulley for rotatably contacting said cable so that the rotational speed of said pulley substantially correlates with the longitudinal movement of said cable, said pulley being mechanically coupled to said shaft outer segment;
said centrifugal brake assembly including
a substantially annular braking ring mounted within said housing, said braking ring defining a radially inwardly located ring braking surface;
a braking actuator rotatably mounted inside said braking ring for rotation about a rotation axis, said braking actuator having at least one substantially outwardly extending actuator arm, said at least one actuator arm defining a radially inwardly located arm inner end, a radially outwardly located arm outer end and an arm contacting surface extending at least partially therebetween;
at least one braking component having a radially outwardly located component braking surface, said braking component being mounted inside said braking ring for contacting said arm contacting surface and sliding at least partially therealong; wherein said at least one braking component is configured, sized and positioned so that upon rotation of said pulley, said rotation is transmitted via said shaft to said braking actuator and via said at least one braking arm to said at least one braking component, the rotation of said at least one braking component generating a centrifugal force acting thereon for moving said at least one braking component radially outwardly from a radially inward position to a radially outward position until biasing said component braking surface against said ring braking surface so as to generate a frictional braking force therebetween;
said pulley including a substantially cylindrical pulley central section and a pair of pulley flanges extending substantially radially outwardly from said pulley central section, each of said pulley flanges defining a corresponding flange inner surface facing substantially towards the opposite pulley flange and an opposed flange outer surface, said pulley central section and said pulley flanges together defining a substantially annular cable bed for receiving a longitudinal portion of said cable, each of said pulley flanges defining a corresponding flange outer peripheral edge, at least one of said flange inner surfaces tapering inwardly towards the opposite flange inner surface in a direction leading from the corresponding flange outer peripheral edge towards said pulley central section; said cable diameter being sized such that the outer surface of said cable is spaced from said pulley central section, the outer surface of said cable only contacting said flange inner surfaces.

51. A device as recited in claim 50 wherein each of said pulley flanges defines a corresponding flange outer peripheral edge, said flange inner surfaces tapering inwardly towards the opposite flange inner surface in a direction leading from the corresponding flange outer peripheral edge towards said pulley central section so that said cable bed has a substantially “V”-shaped cross-sectional configuration.

52. A device as recited in claim 51 wherein said pulley is provided with a pulley friction enhancing means for enhancing the frictional force generated by the contact of said cable with said pulley.
